(19) United States
(12) Patent Application Publication
(10) Pub. No.: US 2022/0128966 A1
(43) Pub. Date: Apr. 28, 2022

(54) Context-Sensitive Technical Audit Trail of A Technical System

(71) Applicant: Siemens Aktiengesellschaft, Muenchen (DE)

(72) Inventors: Benjamin LUTZ, Pfinztal, (DE); Anna PALMIN, Karlsruhe (DE)

(21) Appl. No.: 17/423,165

(22) PCT Filed: Jan. 10, 2020
(86) PCT No.: PCT/EP2020/050487

§ 371 Date: Jul. 15, 2021

(30) Foreign Application Priority Data
Jan. 18, 2019 (EP) 19152614

(51) Int. Cl. G05B 19/4063; G05B 23/02

(52) U.S. Cl. CPC G05B 19/4063; G05B 23/0216; G05B 2219/24042; G05B 2219/35291; G05B 2219/24055; G05B 23/0272

(57) ABSTRACT

A method for controlling a technical system via a control system, wherein the control system, after processing a request from an operator, generates a response message to the request such that if a faulty state of the technical system occurs, then associated fault messages are linked in an automated manner to the request and the response message in the time between the request and the generation of the response message, and a corresponding item of information relating thereto is presented to the operator, where the link between the request, response message and fault messages is provided with a digital signature of the operator who made the request to the control system.

### CROSS-REFERENCE TO RELATED APPLICATIONS

This is a U.S. national stage of application No. PCT/EP2020/050487 filed 10 Jan. 2020. Priority is claimed on European Application No. 19152614 filed 18 Jan. 2019, the content of which is incorporated herein by reference in its entirety.

### BACKGROUND OF THE INVENTION

### 1. Field of the Invention

The invention relates to a control system for a technical system, use of the control system for operating the technical system and to a method for preparing a context-sensitive audit trail for a technical system via the control system in which, the control system, after processing a request from an operator, generates a response message to the request.

### 2. Description of the Related Art

For an audit trail of a process system, process-influencing actions of the operators are detected and archived, for example, when changing a control value in a faceplate, acknowledging an alarm in a message sequence display, and suppressing an alarm in the message sequence display.

In other words, in the context of the audit trail, the intention of the respective operator is detected behind a certain action performed by the operator. The effects of the actions of the operator (motivated by a certain intention) on the process system for an audit trail are generally not included. If an operator action (e.g., when setting a control value) results in system errors, such as the crash of a software component, the failure of monitored hardware, or an impairment of communication by overloads, these subsequent events can only be associated or correlated with the operator action by which they had been triggered with difficulty.

As a rule, such relationships are recognized by an expert based on his experience. He performs a kind of correlation in which, based on his previous experience, he considers how the last operator action could be related to the current system error. However, this process is not mandatory and there is no automated correlation to support this process. Thus, the operator actions leading to the system errors cannot be detected directly as triggers of the system errors and corrected accordingly (to prevent such system errors in the future).

It is true that an operator action and system error messages suspected of being associated can be close to each other in time, such that a certain connection seems to be obvious. However, since a plurality of operator actions usually occur in parallel, particularly in the case of larger technical systems, a concrete, meaningful correlation can only be established with difficulty. Among other things, this is also due to the fact that different types of system error messages are currently not processed and/or stored in a common tool or system, but in different tools/systems.

WO 00/34864 A2 discloses a process control system with a timeout object for limiting requests from operators to the control system.

### SUMMARY OF THE INVENTION

It is an object of the invention to provide an improved method for preparing a context-sensitive audit trail for a technical system with respect to information content and benefits.

This and other objects and advantages are achieved in accordance with the invention by a control system for a technical system, use of the control system for operating the technical system and a method for controlling the technical system via the control system in that when a faulty state of the technical system occurs in the time between the request and the generation of the response message, associated error messages are linked in an automated manner to the request and the response message and a corresponding item of information relating thereto is presented to the operator.

In the present context, a control system is understood to be a computer-aided technical system comprising functionalities for displaying, operating, and managing a technical system such as a manufacturing or production system. In the present case, the control system comprises sensors for determining measured values as well as various actuators. In addition, the control system comprises so-called process or production-related components that are used to control the actuators or sensors. Furthermore, the control system comprises, inter alia, means for visualizing the technical system and for engineering. In addition, the term control system also encompasses further computing units for more complex controls and systems for data storage and processing.

A technical system is to be understood here as meaning a plurality of machines, devices, applications or the like that are functionally and often also spatially related to one another. With the technical system, for example, products, components, and the like can be generated or manufactured in (large-scale) technical dimensions. However, the technical system may, for example, also be an automobile, a ship, an airplane, or the like.

An operator is understood to be a human operator of the technical system. The operator interacts with the technical system or its control system via special user interfaces and controls special technical functions of the system. The operator can use an operating and monitoring system of the control system for this purpose.

A request from the operator can be, for example, the setting of a control value of a controller of the technical system. The operator makes the request to the control system, which first reads out the request in the course of processing and interprets its content in the context of previously defined rules. Depending on the content of the request, various devices/components of the technical system are addressed by the control system. In the case of setting a control value of a controller, the request may, inter alia, contain information about a before-value and an after-value and an identifier of the object of the technical system to be addressed.

A message is generally understood to mean a report on the occurrence of an event that represents a transition from one discrete state within the technical system to another discrete state. This makes it possible for the operator or operators to be precisely informed as early as possible about the consequence or result of their actions (the consequence of their requests) in the respective system context. For this purpose, the control system offers the operator the linked information, such as via a client of a server of the control system suitable for this purpose.

If a faulty state of the technical system occurs, a link between the at least one fault event and the request or the associated response message is established in an automated manner via the control system in accordance with the invention. In other words, the fault event is correlated with the request or response message.

With the context-sensitive, binding configuration of the audit trail, precisely tailored to the respective configuration data and the system status and which is made possible by the present invention, the audit trail gains significantly in information content and benefits with respect to various evaluations at runtime and thereafter. As a result, the evaluations deliver much more precise results and can be used to good effect not only for audit purposes, but also for optimizing the system processes of the technical system.

As a result of the operator being informed as early as possible and with great precision about the consequence or the result of his actions in the respective system context, a sound contribution can be made to making the work of the operator more efficient and less prone to error. In addition, new operators can be trained more easily with the aid of the method in accordance with the invention.

In accordance with the invention, the link between the request, response message and error messages is provided with a digital signature of the operator who made the request to the control system. This achieves the highest possible commitment and non-repudiation of the request made by the operator and the associated error messages of the technical system. Signing ensures the protection of the integrity and the authenticity of the audit trail entries. With the link, it can easily be concluded in retrospect that errors occurred during the execution of the operator actions about which the operator was informed, and which can be clearly assigned to the respective operator.

The error messages can be system messages, diagnostic messages, traces, logs and/or security events.

The term system messages should be understood to mean preconfigured messages which, for example, are generated when a connection is lost (“Connection lost after timeout: operator station—automation station”). These messages are intended as additional information for maintenance and diagnosis and of a medium level of detail.

Traces are detailed and diverse information that originates directly from software components of the technical system and has a high level of detail. This information goes beyond the “maintenance and diagnosis” information of the system messages and is usually intended for technical support of the technical system.

Logs or security events are predefined security-relevant events implemented in system components of the technical system, which events are generated by the system components as soon as certain pre-defined security-relevant events occur.

Within the scope of an advantageous embodiment of the invention, the control system requests an acknowledgement from the operator of the response message associated with his request after linking the request and the associated response message with the error messages. As a result, it can be ensured that the operator can also have knowledge of the link intended for him. Acknowledgement and digital signing make the audit trail binding and tamper-proof with respect to security. They clearly demonstrate that the respective operator has not only triggered certain actions but has also been informed about their consequences (possibly several times).

The following steps are preferably performed by the control system in the context of linking the error messages with the request and the response message after the request has been received in the control system:
a) Determination of components of the technical system that are affected by the request from the operator;
b) Determination of error messages relating to the previously identified components that occur while the request from the operator is being processed;
c) After processing the request from the operator, generation of the response message;
d) Linking of request, response message and error messages.

Firstly, after the request has been received in the control system, the components of the technical system affected by the respective operator request are determined by the control system. In the case of a process system, an operator station server is primarily concerned, to which the operator is logged on via an operator station client belonging to the server (current status). For example, in the case of a change in the control value of a controller, it is checked in which operator station server its process data are located in the process image. Furthermore, a check is performed to determine which other dependent devices (such as an automation system) are affected by the request. As an overall result, it is thus possible to determine which devices are involved in executing the operator request, and thus also from which devices information can be obtained in order to be able to detect the system behavior of the technical system during the processing of the request. A type of device filter is defined, which allows information about the devices from which system messages, traces, diagnostic messages, security events and the like can be obtained, which may be associated with the operator request.

On the basis of the previously determined device filter, all newly occurring system messages, traces, diagnostic messages, security events, etc. are received (and temporarily stored) during the processing of the operator request in a second step.

After completion of the processing of the operator request, a response message is generated which is linked or correlated with the request and the error message or error messages.

It is also an object of the invention to provide a control system for a technical system, in particular a manufacturing or process system, which is configured to implement the above-described method in accordance with the disclosed embodiments.

In addition, the object is achieved by the use of such a control system for operating a technical system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The properties, features and advantages of this invention described above and the manner in which these are achieved, will become clearer and more readily understandable in connection with the following description of the exemplary embodiment which is explained in more detail in connection with the drawing, in which:

FIG. 1 is a schematic illustration of part of a control system in accordance with the invention formed as a process system; and

FIG. 2 is a flowchart of the method in accordance with the invention.

### DETAILED DESCRIPTION OF THE EXEMPLARY EMBODIMENTS

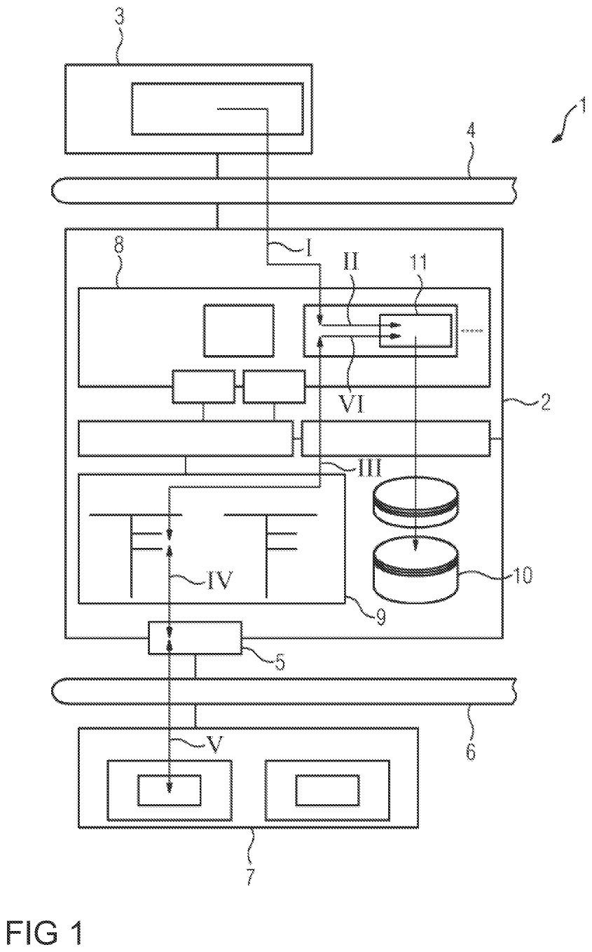

FIG. 1 shows part of a control system 1 according to the invention of a technical system formed as a process system. The control system 1 comprises a server of an operating system or an operator station server and an associated operator station client 3. The operator station server 2 and the operator station client 3 are connected to one another via a terminal bus 4 and to other components of the control system 1 (not shown), such as an engineering system server or a process data archive.

A user or operator has access to the operator station server 2 via the operator station server 3 via the terminal bus 4 in the context of operation and observation. The terminal bus 4 can, without being limited thereto, be formed, for example, as an Industrial Ethernet.

The operator station server 2 has a device interface 5 that is connected to a system bus 6. The operator station server 2 can then communicate with an (external) device 7 (here an automation station). The connected device 7 may alternatively also be an application, in particular a web application. Within the scope of the invention, any number of devices and/or applications can be connected to the operator station server 2. The system bus 6 can, without being limited thereto, be formed, for example, as an Industrial Ethernet. The device 7 can in turn be connected to any number of subsystems (not shown).

A visualization service 8 is integrated in the operator station server 2, via which (visualization) data can be transmitted to the operator station client 3. In addition, the operator station server 4 has a process image 9 and a local archive 10.

An audit trail service 11 is implemented within the visualization service 8, the mode of operation and function of which are explained hereinafter.

An operator changes a control value of a controller of a process object of the process system in the operator station client 3. This information or request is transmitted from the operator station client 3 to the operator station server 2 (step I) and is read out there (inter alia) by the audit trail service 11 (step II).

The audit trail service 11 then creates an operating message and determines the devices 7 or process objects affected by the request from the operator. In addition, the audit trail service 11 receives all the error messages that describe a faulty state of the process system from the affected devices 7 or process objects and/or the local archive 10 until the processing of the request from the operator has been completed.

The request from the operator is initially processed in a step III in that the change in the control value is written into the process image 9. The device interface 5 or the device driver forwards the requested control value changes to the automation station 7 (step IV, V). Here, the change in control value is undertaken and corresponding feedback is given to the device interface 5 and the process image.

The audit trail service 11 is informed by the automation station 7 via its feedback as to whether the change in control value could be carried out successfully. Regardless of the success of the change in control value, the audit trail service 11 generates a response message to be acknowledged by the operator when the audit trail service 11 has received error messages from the devices 7 or process objects affected by the request in the time between the receipt of the request and the completion of the processing of the request. The response message, the request and the associated error messages are linked in an automated manner by the audit trail service 11 and are stored in the local archive 10 for later checking as well as presented to the operator for acknowledgement.

Any acknowledgement of the response message that may have been given by the operator is then also stored in the archive 10. The archive 10 need not necessarily be implemented locally on the operator station server 2, but can also be implemented separately from the operator station server 2, such as in a cloud-based environment. A cloud is understood to mean a computer network with online-based storage and server services, which is usually referred to as a cloud or cloud platform. The data saved in the cloud is accessible online, so that the process system also has access to a central data archive in the cloud via the internet.

Although the invention has been illustrated and described in detail by the preferred exemplary embodiment, the invention is not limited by the disclosed examples and other variations may be derived therefrom by a person skilled in the art without departing from the scope of the invention.

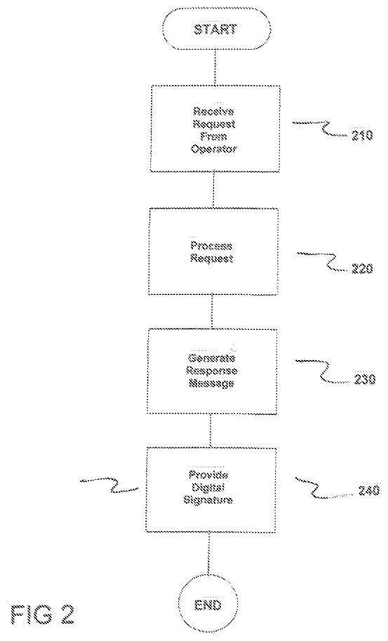

FIG. 2 is a flowchart of a method for preparing a context-sensitive audit trail for a technical system via a control system 1. The method comprises receiving a request at the control system 1 from an operator, as indicated in step 210.

Next, the request from the operator is processed by the control system 1, as indicated in step 220.

Next, the control system 1 generates an appropriate response message to the request if a faulty state of the technical system occurs in a time between the request to the control system and generation of the response message after the processing of the request, as indicated in step 230. Here, associated error messages are correlated in an automated manner with the request and the response message and a corresponding item of information relating thereto is presented to the operator.

Next, a digital signature of the operator who made the request to the control system 1 is provided to a link between the request, response message and error messages, as indicated in step 240. Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A method for preparing a context-sensitive audit trail for a technical system via a control system, the method comprising:
receiving a request at the control system from an operator;
processing the request from the operator by the control system;
generating, by the control system, an appropriate response message to the request if a faulty state of the technical system occurs in a time between the request to the control system and generation of the response message after the processing of the request, associated error messages being correlated in an automated manner with the request and the response message and a corresponding item of information relating thereto being presented to the operator; and
providing a digital signature of the operator who made the request to the control system to a link between the request, response message and error messages.

8. The method as claimed in claim 7, wherein the error messages comprise at least one of (i) system messages, (ii) diagnostic messages, (iii) traces, (iv) logs and (v) security events.

9. The method as claimed in claim 7, wherein the control system requests an acknowledgement of the response message associated with its request from the operator after the linking of the request and the associated response message to the error messages.

10. The method as claimed in claim 8, wherein the control system requests an acknowledgement of the response message associated with its request from the operator after the linking of the request and the associated response message to the error messages.

11. The method as claimed in claim 7, wherein as part of the linking of the error messages to the request and the response message after the request has been received in the control system, the control system:
a) determines components of the technical system which are affected by the request from the operator;
b) determines error messages relating to a previously identified components which occur while the request from the operator is being processed;
c) after processing the request from the operator, generation of the response message;
d) links request, response message and error messages.

12. A control system for a technical system, the control system comprising:
a processor; and
memory;
wherein the control system is configured to:
receive a request from an operator;
process the request from the operator;
generate an appropriate response message to the request if a faulty state of the technical system occurs in a time between the request to the control system and generation of the response message after the processing of the request, associated error messages being correlated in an automated manner with the request and the response message and a corresponding item of information relating thereto being presented to the operator; and
provide a digital signature of the operator who made the request to the control system to a link between the request, response message and error messages.

13. The control system of claim 12, wherein the technical system comprises one of a manufacturing or process system.

14. The control system of claim 12, wherein the control system controls the technical system during operation thereof

15. The control system of claim 14, wherein the technical system comprises one of a manufacturing or process system.
